(19) United States
(12) Patent Application Publication
(10) Pub. No.: US 2009/0085870 A1
(43) Pub. Date: Apr. 2, 2009

(54) Multimedia device

(75) Inventor: Sean Mosko, Taipei (TW)

Correspondence Address: BACON & THOMAS, PLLC, 625 SLATERS LANE, FOURTH FLOOR, ALEXANDRIA, VA, 22314-1176, US

(73) Assignee: FIRST INTERNATIONAL COMPUTER, INC., Taipei (TW)

(21) Appl. No.: 11/905,008

(22) Filed: Sep. 27, 2007

(51) Int. Cl. G09G 5/30

(52) U.S. Cl. 345/158

(57) ABSTRACT

A multimedia device includes a display device, a storage device, an orientation sensor and a processing unit. The storage device has a plurality of programs, and each of which is capable of rendering of an operation interface on the display device. The orientation sensor is capable of detecting the disposed orientation of the display device and sending an orientation signal. The processing unit electrically connected to the display device, the storage device and the orientation sensor. The operation interface shown on the display device is determined by the processing unit in accordance with the orientation signal emitted from the orientation sensor.

### BACKGROUND OF THE INVENTION

1. Field of the Invention

The present invention relates to a multimedia device, and, more particularly, to a multimedia device which allows users to switch program interfaces conveniently without having to push buttons.

2. Description of the Related Art

With the developments in technology, many electronic devices offer significantly more convenience and practicability for users, such as a mobile phone for communication, a GPS device for tracking vehicle, an MP3 player or a media player for entertainment. Because these products have different kinds of functions, users have to buy many products in order to satisfy different needs; however, it is very inconvenient to carry all kinds of the products and connectors in travel. Accordingly, more and more manufacturers offer multifunctional devices to meet users' needs.

Since multifunctional devices provide more than one function, users have to switch between different functions when they want to use a specific function. In general, users switch a function by pressing buttons to enter a system menu and select the function they want. Because users will always need to press buttons repeatedly before selecting a specific function, devices with too many functions inevitably impose much trouble on users, largely decreasing their willingness to buy or even use these kinds of devices.

It is therefore desirable to provide a multimedia device to mitigate and/or obviate the aforementioned problems.

### SUMMARY OF THE INVENTION

A main object of the present invention is to provide a multimedia device, and, more particularly, to provide a multimedia device for a user to switch program interfaces more conveniently.

In order to achieve the object, the multimedia device includes a display device, a storage device, an orientation sensor and a processing unit. The storage device has a plurality of programs, and each of which is capable of rendering of an operation interface on the display device. The orientation sensor is capable of detecting the disposed orientation of the display device and sending an orientation signal. The processing unit electrically connected to the display device, the storage device and the orientation sensor. The operation interface shown on the display device is determined by the processing unit in accordance with the orientation signal emitted from the orientation sensor.

### BRIEF DESCRIPTION OF THE DRAWINGS

FIG. 1 is a block diagram corresponding to the multimedia device of the present invention.

FIGS. 2(a) and 2(b) illustrate the statuses of the present invention under operation.

FIG. 3 illustrates another status of the present invention under operation.

### DETAILED DESCRIPTION OF THE PREFERRED EMBODIMENT

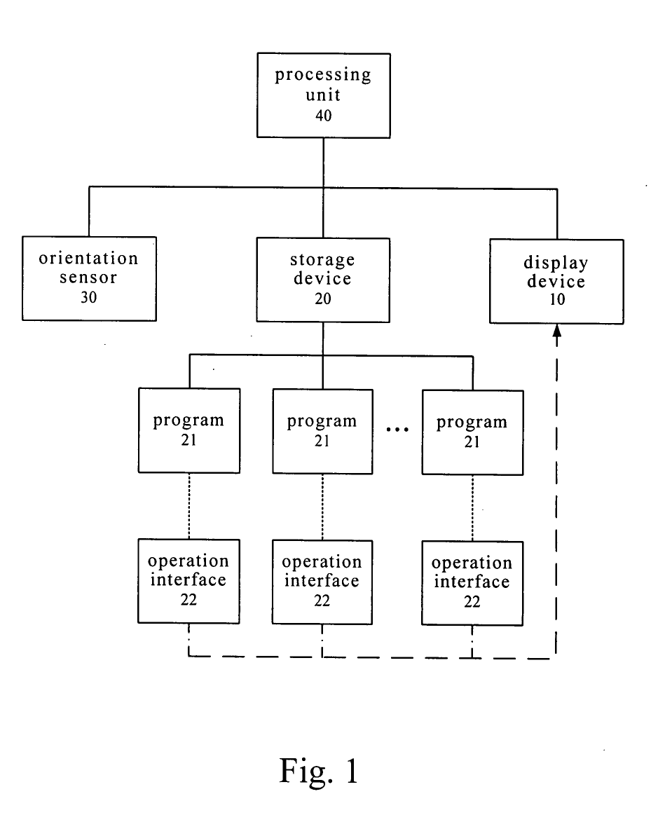

Please refer to FIG. 1. FIG. 1 is a block drawing showing the relationship among different components of the present invention. A multimedia device 1 includes a display device 10, a storage device 20, an orientation sensor 30 and a processing unit 40. The storage device 20 has a plurality of programs 21, and each of which is capable of rendering of an operation interface 22 on the display device 10. The orientation sensor 30 is capable of detecting the disposed orientation of the display device 10 and sending an orientation signal. The processing unit 40 electrically connected to the display device 10, the storage device 20 and the orientation sensor 30. The operation interface 22 shown on the display device 10 is determined by the processing unit 40 in accordance with the orientation signal emitted from the orientation sensor 30. In this embodiment, the orientation sensor 30 is an accelerometer or gyroscopes.

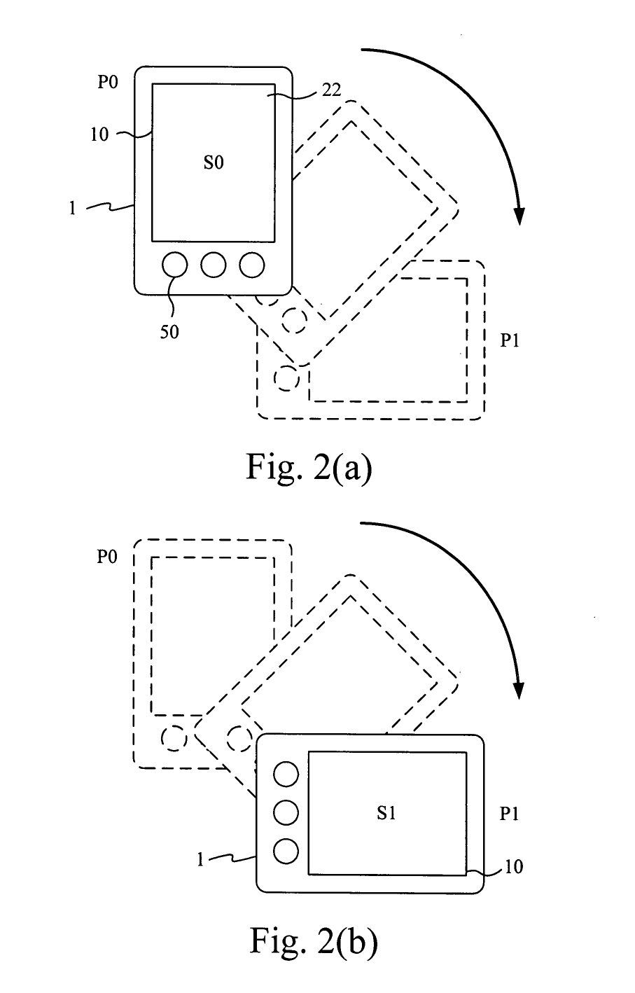

Please refer to FIG. 2(a) and FIG. 2(b). FIGS. 2(a) and (b) shows the status of the present invention under operation. In the figures, the operation interface 22 shown on the display device 10 at an initial disposed orientation P0 of the multimedia device 1 is an initial operation interface S0. When the multimedia device 1 rotates clockwise, the orientation sensor 30 is capable of detecting the change of the disposed orientation of the display device 10 and sending an orientation signal, and the processing unit 40 may receive the orientation signal and compare it with its initial state. When the multimedia device 1 rotates to the first predetermined disposed orientation P1, the processing unit 40 may then compare the orientation signal emitted from the orientation sensor 30 with its initial state and switch to the first operation interface S1 corresponding to the first predetermined disposed orientation P1 in accordance with the orientation signal. For example, if the initial operation interface S0 is an MP3 player program interface and the first operation interface S1 is a GPS program interface, when the user wants to switch the MP3 player program interface to the GPS program interface, he needs only to rotate the multimedia device 1 clockwise from initial disposed orientation P0 to the first predetermined disposed orientation P1 without pressing any button. Conversely, when the user wants to switch the GPS program interface to the MP3 player program interface, he needs only to rotate multimedia device 1 anticlockwise from the first predetermined disposed orientation P1 to initial disposed orientation P0.

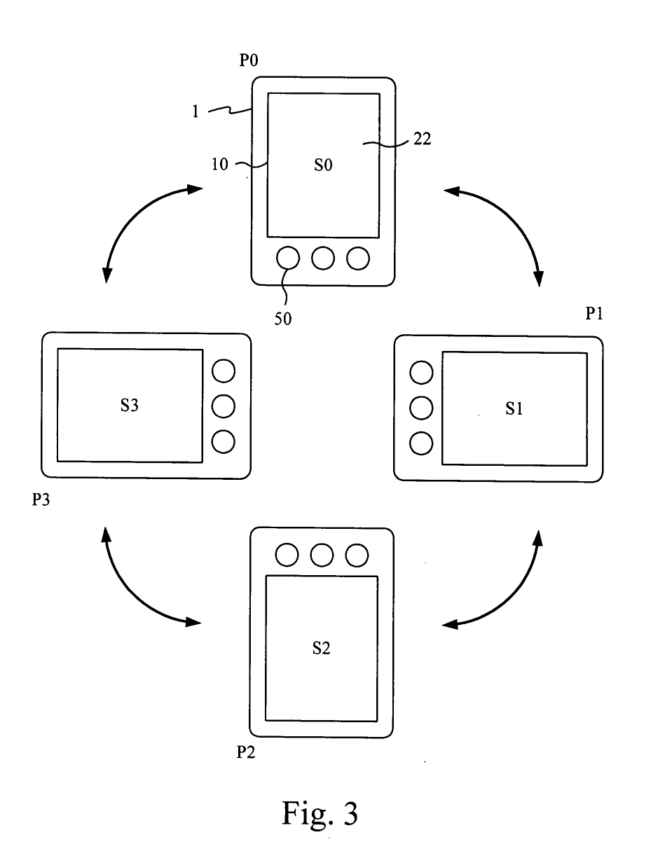

Please refer to FIG. 3. FIG. 3 shows another status of the present invention under operation. The multimedia device 1 may be set at least one predetermined disposed orientation so as to switch the operation interface 22 corresponding to the predetermined disposed orientation. The multimedia device 1 may be set to each predetermined disposed orientation to switch the operation interface 22 in accordance with the number of the programs 21 or the requests of users. In this embodiment, the multimedia device 1 has four kinds of programs 21. Because a complete circle of the multimedia device 1 is around 360°, each predetermined disposed orientation will be set substantially an integer multiple of 90° corresponding to switching each the operation interface 22 of the program 21. In other words, the operation interface 22 is switched when the angular variation of the disposed orientation of the display device 10 approaches substantially 90° every time. When the multimedia device 1 is at the initial disposed orientation P0, the operation interface 22 shown on the display device 10 is the initial operation interface S0; when the multimedia device 1 rotates to the first predetermined disposed orientation P1, the operation interface 22 shown on the display device 10 is switched to the first operation interface S1; when the multimedia device 1 rotates to the second predetermined disposed orientation P2, the operation interface 22 shown on the display device 10 is switched to the second operation interface S2; when the multimedia device 1 rotates to the third predetermined disposed orientation P3, the operation interface 22 shown on the display device 10 is switched to the third operation interface S3; in addition, when the multimedia device 1 rotates to the initial disposed orientation P0, the operation interface 22 shown on the display device 10 is switched to the initial operation interface S0 again. The display device 10 at the different disposed orientation may show the different operation interface 22.

Furthermore, the operation interface 22 may be set according to each predetermined disposed orientation of the display device 10. Each operation interface 22 corresponding to the predetermined disposed orientation may be changed. In other words, the user may change each operation interface 22 corresponding to the predetermined disposed orientation in accordance with individual preference or practicality of programs. In this embodiment, each operation interface 22 corresponding to the predetermined disposed orientation is selected from the group consisting of an MP3 player program interface, a GPS program interface, a PDA phone interface, and an image display program interface.

The multimedia device 1 further includes a plurality of buttons 50 for controlling the operation interface 22 or select menu commands. The user may also switch the operation interface 22 by buttons 50 when the operation interface 22 cannot be switched by detecting the change of the disposed orientation of the display device 10. The operation interface 22 may be operated not only by buttons 50 but also by a touch panel; however, the present invention is not confined to these devices. Furthermore, the operation interface 22 shown on the display device 10 may be locked. When the user switched the objective operation interface 22, the operation interface 22 shown on the display device 10 may be locked by pushing the button 50. At this time, the processing unit 40 may stop comparing the orientation signal emitted from the orientation sensor 30, and the operation interface 22 will not be changed. It may avoid that the operation interface 22 in use is switched if the user changes the disposed orientation of the multimedia device 1 carelessly.

Although the present invention has been explained in relation to its preferred embodiment, it is to be understood that many other possible modifications and variations can be made without departing from the spirit and scope of the invention as hereinafter claimed.

What is claimed is:

1. A multimedia device, including:
a display device;
a storage device having a plurality of programs, each of which is capable of rendering of an operation interface on the display device;
an orientation sensor being capable of detecting the disposed orientation of the display device and sending an orientation signal accordingly;
a processing unit electrically connected to the display device, the storage device and the orientation sensor;
the operation interface shown on the display device being determined by the processing unit in accordance with the orientation signal emitted from the orientation sensor.

2. The multimedia device of claim 1, wherein the orientation sensor is an accelerometer.

3. The multimedia device of claim 1, wherein the orientation sensor is a gyroscope.

4. The multimedia device of claim 1, wherein the display device may set at least one predetermined disposed orientation so as to switch the operation interface corresponding to the predetermined disposed orientation.

5. The multimedia device of claim 1, wherein the operation interface may be set according to each predetermined disposed orientation of the display device.

6. The multimedia device of claim 1, wherein the operation interface shown on the display device may be locked.

7. The multimedia device of claim 1, further including a plurality of buttons for operating the operation interface.

8. The multimedia device of claim 1, wherein the display device is a touch panel.

9. The multimedia device of claim 1, wherein the operation interface is selected from the group consisting of an MP3 player program interface, a GPS program interface, a PDA phone interface, and an image displaying program interface.
